(19) United States
(12) Patent Application Publication
(10) Pub. No.: US 2025/0234896 A1
(43) Pub. Date: Jul. 24, 2025

(54) DISPENSING ASSEMBLY FOR A DRINK MAKER

(71) Applicant: SharkNinja Operating LLC, Needham, MA (US)

(72) Inventors: Macrae Benziger, Dedham, MA (US); Michael Lerman, Providence, RI (US); Alexander Mularski, Auburn, MA (US)

(73) Assignee: SharkNinja Operating LLC, Needham, MA (US)

(21) Appl. No.: 18/423,721

(22) Filed: Jan. 26, 2024

Related U.S. Application Data
(63) Continuation-in-part of application No. 18/415,817, filed on Jan. 18, 2024.

(51) Int. Cl. A23G 9/28; A23G 9/04; B67D 1/14

(52) U.S. Cl. CPC A23G 9/28; A23G 9/045; B67D 1/1477

(57) ABSTRACT

A dispensing assembly for a frozen drink maker has a housing including a first portion attached to an outer surface of the frozen drink maker adjacent to a spout and a second portion spaced apart from the spout and extending outward from the outer surface. A lever attached to the second portion of the housing is rotatable relative to the second portion of the housing about a first pivot member. A seal operatively coupled to the lever is configured to seal the spout in a closed position. Rotation of the lever causes the seal to move into an open position to allow dispensing of a drink product through the spout.

### CROSS-REFERENCE TO RELATED APPLICATIONS

This application is a continuation-in-part of U.S. application Ser. No. 18/415,817, filed on Jan. 18, 2024, entitled REMOVEABLE COLLECTION TRAY FOR A DRINK MAKER, the entire contents of which are incorporated herein by reference for all purposes.

### TECHNICAL FIELD

The present disclosure relates to a frozen drink makers and, more particularly, to a frozen drink maker including a low maintenance dispense system.

### BACKGROUND

Frozen drink makers, which may also be referred to as semi-frozen beverage makers or crushed-ice drink makers, typically include a transparent tank or mixing vessel in which a drink product is received and processed, including being cooled, often transforming the drink product from a pure liquid (or a combination of a liquid and portions of ice) to a frozen or semi-frozen product, such as, for example, a granita, slush drink, smoothie, ice cream, or other frozen or semi-frozen product, which is then dispensed. The cooled product is typically dispensed through a tap, spigot or dispenser located at the front and near the bottom of the vessel. Thus, the term “frozen drink maker” as used herein is not limited to a device that only makes drinks or frozen drinks but includes devices that cool received drink products to produce cooled outputs in any of a variety of cooled, frozen and semi-frozen forms. A drink product typically consists of a mixture of water or milk, a syrup, flavoring powders, or other additives that give the drink product the desired taste and color.

Some existing frozen drink makers include a mixing system within the mixing vessel having a mixing blade or auger that is rotated by a motor via a drive shaft and drive assembly. Some existing frozen drink makers include a refrigeration system having a compressor, a condenser and an evaporator (i.e., chiller) for receiving refrigerant from the compressor where the evaporator is located adjacent to or within the mixing vessel to cool the drink product during processing. Typically, a dispensing mechanism uses a plunger seal to open and close a spout on the frozen drink maker to dispense the drink product.

Some existing frozen drink makers include a controller that controls operations of the frozen drink maker related to making drink products, including the temperature of frozen food products during processing.

### SUMMARY

The disclosure describes a low-maintenance dispensing system for a frozen drink maker that uses a lip seal rather than a plunger seal. The dispensing mechanism includes several pivoting linkages that operate to swing the seal up when a user actuates a dispensing lever. In the open position, the seal is angled about 45-60 degrees with respect to the spout, which helps to direct the dispensed drink product downward. The spout opening also includes a safety grate to prevent the user from inadvertently inserting his or her fingers into the spout.

This application describes illustrative systems, methods, and devices that provide a dispensing assembly for dispensing a drink product through a spout of a frozen drink maker.

In some exemplary implementations, a dispensing assembly for a frozen drink maker of this disclosure includes a housing having a first portion attached to an outer surface of the frozen drink maker adjacent to a spout, and a second portion spaced apart from the spout and extending outward from the outer surface. A lever attaches to the second portion of the housing. The lever is rotatable relative to the second portion of the housing about a first pivot member. A seal operatively couples to the lever. The seal is configured to seal the spout in a closed position. Rotation of the lever causes the seal to move into an open position to allow dispensing of a drink product through the spout.

In some implementations, a link member operatively couples to the lever. The link member is rotatable relative to the lever about a second pivot member. A bracket member operatively couples to the link member and attaches to the first portion of the housing. The bracket member is rotatable relative to the link member about a third pivot member and rotatable relative to the first portion of the housing about a fourth pivot member. The seal is attached to the bracket member.

In some implementations, the second pivot member is a pin extending through the lever and through the link member. In some implementations, the third pivot member is a pin extending through the bracket member and through the link member. In some implementations, the fourth pivot member is a pin extending through the first portion of the housing and through the bracket member. In some implementations, the seal is angled at about 45-60 degrees with respect to the spout when the seal is in the open position. In some implementations, the spout includes a grate configured to prevent a user from inserting fingers into the spout. In some implementations, the first pivot member includes a pin extending through the second portion of the housing and through the lever. In some implementations, the seal is a lip seal. In some implementations, the bracket member is L-shaped. In some implementations, the housing is L-shaped.

In some implementations, a method of dispensing a drink product through a spout of a frozen drink maker of this disclosure includes rotating a lever about a first pivot member relative to a second portion of a housing of a dispensing assembly. The housing further includes a first portion attached to an outer surface of the frozen drink maker adjacent to the spout and the second portion spaced apart from the spout and extending outward from the outer surface. Rotating the lever causes a seal operatively coupled to the lever to move into an open position to allow dispensing of the drink product through the spout. The seal is configured to seal the spout in a closed position.

In some implementations, the dispensing assembly further includes a link member operatively coupled to the lever, and rotating the lever causes the link member to rotate relative to the lever about a second pivot member. In some implementations, the dispensing assembly further includes a bracket member operatively coupled to the link member and attached to the first portion of the housing, and rotating the lever causes the bracket member to rotate relative to the link member about a third pivot member and to rotate relative to the first portion of the housing about a fourth pivot member. In some implementations, the seal is attached to the bracket member.

One of ordinary skill will recognize that the systems, methods, and devices described herein may apply to other types of food products such as to the making and/or processing of, without limitation, ice cream, frozen yogurt, other creams, and the like. While the present disclosure describes examples of a drink maker processing various frozen and/or semi-frozen drink products, the systems, devices, and methods described herein are not limited to such drink products and are capable of processing and/or making other types of drink products such as cooled drink products and/or chilled drink products. The terms “mix,” “mixed” or “mixing” as used herein are not limited to combining multiple ingredients together, but also include mixing a drink product or liquid having a single or no added ingredients. For example, a drink product may consist of only water that is mixed by a dasher during processing, i.e., portions of the water are churned and/or intermingled as the dasher rotates. This may, for example, advantageously enable a more uniform temperature of the water and/or liquid as a whole within the mixing vessel by intermingling portions of the water and/or liquid having different temperatures.

A reading of the following detailed description and a review of the associated drawings will make apparent the advantages of these and other structures. Both the foregoing general description and the following detailed description serve as an explanation only and do not restrict aspects of the disclosure as claimed.

### BRIEF DESCRIPTION OF THE DRAWINGS

Reference to the detailed description, combined with the following figures, will make the disclosure more fully understood, wherein:

FIG. 1 shows a perspective view of a frozen drink maker according to an implementation of the disclosure;

FIG. 2 shows a view of various internal components within the housing and mixing vessel of the frozen drink maker of FIG. 1 according to an implementation of the disclosure;

FIG. 3 shows a front view of the frozen drink maker of FIG. 1 according to some implementations of the disclosure;

FIG. 4 is a block diagram of an example of a control system of the frozen drink maker of FIG. 1, according to some implementations of the disclosure;

FIGS. 5A-5D show a dispensing assembly for dispensing a drink product from the frozen drink maker according to an implementation of the disclosure;

FIGS. 6A-6B show a dispensing assembly for dispensing a drink product from the frozen drink maker according to another implementation of the disclosure; and

FIGS. 7A and 7B show a shroud for covering the dispensing assembly of FIGS. 5A-5D and FIGS. 6A-6B according to an implementation of the disclosure.

### DETAILED DESCRIPTION

In the following description, like components have the same reference numerals, regardless of different illustrated implementations. To illustrate implementations clearly and concisely, the drawings may not necessarily reflect appropriate scale and may have certain structures shown in somewhat schematic form. The disclosure may describe and/or illustrate structures in one implementation, and in the same way or in a similar way in one or more other implementations, and/or combined with or instead of the structures of the other implementations.

In the specification and claims, for the purposes of describing and defining the invention, the terms “about” and “substantially” represent the inherent degree of uncertainty attributed to any quantitative comparison, value, measurement, or other representation. The terms “about” and “substantially” moreover represent the degree by which a quantitative representation may vary from a stated reference without resulting in a change in the basic function of the subject matter at issue. Open-ended terms, such as “comprise,” “include,” and/or plural forms of each, include the listed parts and can include additional parts not listed, while terms such as “and/or” include one or more of the listed parts and combinations of the listed parts. Use of the terms “top,” “bottom,” “above,” “below” and the like helps only in the clear description of the disclosure and does not limit the structure, positioning and/or operation of the disclosure in any manner.

The application, in various implementations, addresses deficiencies associated with plunger seals, including known issues of failing seals caused by rubbing of the elastomeric seal in typical dispenser designs. These issues include the need to replace the seals and to continually apply lubricant to the seals, both of which are unacceptable for in-home users. Accordingly, there is a need for a dispensing system that eliminates the rubbing of the elastomeric seal.

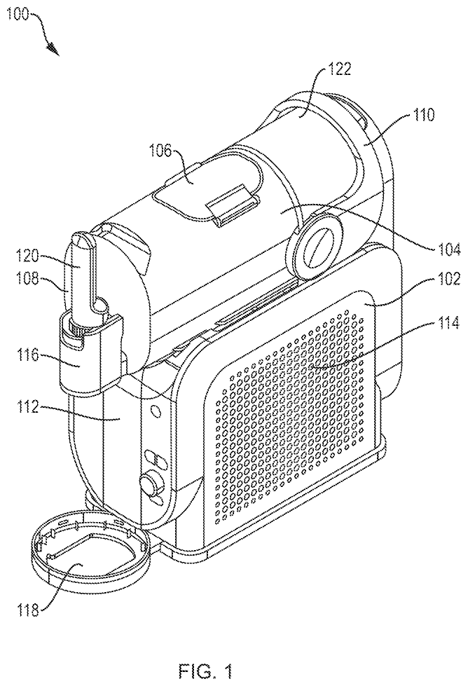

FIG. 1 shows a perspective view of a frozen drink maker 100 according to an illustrative implementation of the disclosure. The frozen drink maker 100 includes a housing 102 and mixing vessel 104. The housing 102 may include user interface 112 for receiving user inputs to control frozen drink maker 100 and/or to output or display information. User interface 112 may include one or more buttons, dials, switches, touchscreens, indicators, LEDs, and the like. User interface 112 may display status information including for example, a temperature of a drink product within mixing vessel 104, an indicator of a recipe and/or program currently being implemented, a timer associated with the progress of a recipe and/or program in progress and/or currently being implemented. User interface 112 may provide indicators and/or warnings to users regarding, for example, when a recipe is complete or when a user is expected to perform an action associated with processing a drink product. User interface 112 may include a selectable menu of drink types (e.g., recipes) and/or programs for different types of drink products such as, without limitation, granita, smoothie, margarita, daiquiri, pina colada, slushie, cocktail, frappe, juice, diary, milk shake, cool drink, semi-frozen drink, frozen drink, and the like.

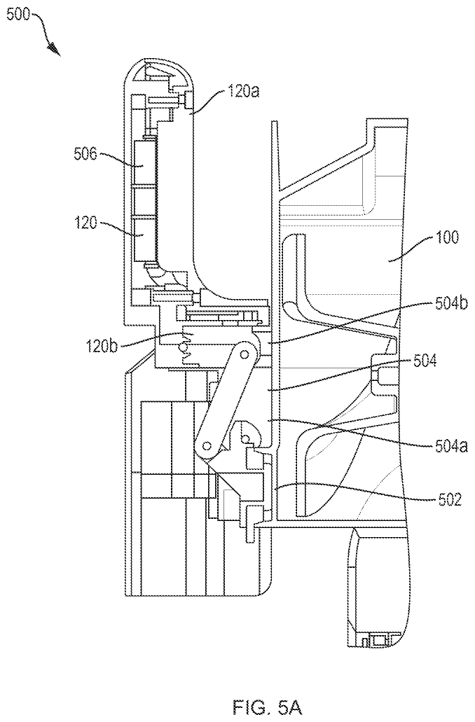

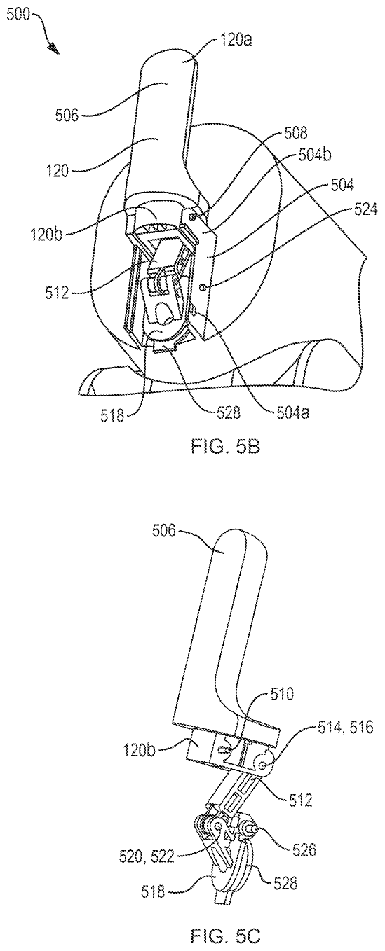

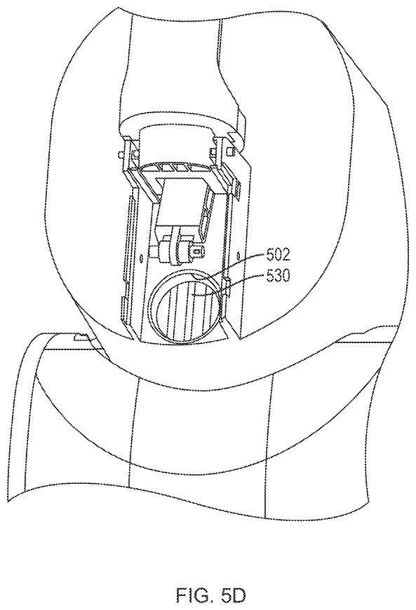

Still referring to FIG. 1, housing 102 may include a panel (e.g., a removable panel) 114 along a side of the housing 102. Panel 114 may include a plurality of openings that facilitate air flow to aid in cooling components within housing 102. Housing 102 may include upper housing section 122 that is arranged to couple with a rear end of mixing vessel 104 when mixing vessel 104 is attached to housing 102. Mixing vessel 104 may include walls, or a portion thereof, that are transparent to enable a viewer to see a drink product within mixing vessel 104 during processing. Mixing vessel 104 may include pour-in opening 106 whereby mixing vessel 104 can receive ingredients for processing a drink product within mixing vessel 104. FIG. 1 shows pour-in opening (not shown) in a closed configuration with a cover 106 sealing the opening. The cover 106 may be detachably removable or moveable to open or close the opening. Pour-in opening may include a safety grate (not shown) to inhibit a user from reaching into mixing vessel 104 when the cover 106 is not installed. Mixing vessel 104 may include a dispenser assembly 108 having a user handle 120, a spout 502 (FIG. 5A), and a spout cover or shroud 116. Dispenser assembly 108 enables a user, by pulling down on handle 120, to open the spout, connected to a wall of mixing vessel 104, to dispense a processed (e.g., cooled) drink product from mixing vessel 104. The user can close the spout by pushing handle 120 back to its upright position (shown in FIG. 1) and, thereby, stop the dispensing of the processed drink product.

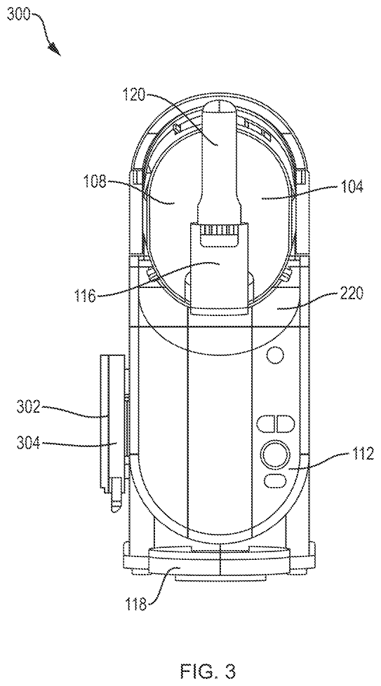

Still referring to FIG. 1, frozen drink maker 100 may include a lever 110 that enables a locked coupling of mixing vessel 104 to housing 102 including upper housing section 122. FIG. 1 shows lever 110 in the locked and/or closed position whereby mixing vessel 104 is engaged and/or coupled to housing 102 and upper housing section 122. In the closed and/or engaged position, lever 110 ensures that there is a water-tight seal to prevent leakage of drink product from mixing vessel 104. Lever 110 may be placed in the closed, coupled, and/or engaged position by sliding mixing vessel 104 against upper housing section 122 and then rotating lever 110 in a clockwise direction until its handle rests on or about the top surface of upper housing section 122. Mixing vessel 104 can be disengaged and/or decoupled from housing 102 and upper housing section 122 by pulling and/or rotating lever 110 in a counterclockwise direction (from the perspective of FIG. 1) toward the front of mixing vessel 104, which causes lever 110 to release mixing vessel 104. Once released and/or decoupled, mixing vessel 104 may slide in a forward direction (away from upper housing section 122) to be fully detached and/or removed from housing 102. Mixing vessel 104 may include a radial seal and/or face seal. The face seal may provide an improved seal based on compression provided by lever 110 pushing mixing vessel 104 laterally against a wall of upper housing section 122. Mixing vessel 104 may include a circular and/or cylindrical opening at its rear end that couples mixing vessel 104 to upper housing section 122. An interlock switch may be implemented at the upper housing section 122 that is activated when mixing vessel 104 is coupled to upper housing section 122 that prevents activation of drive motor 208 unless vessel 104 is coupled to upper housing section 122. This ensures that a user is not exposed to a moving dasher 204. Frozen drink maker 100 may also include drip tray 118 being positioned below dispenser assembly 108 and arranged to collect any drink product that is not properly dispensed from mixing vessel 104 to, for example, a user cup. Drip tray 118 may be attachably removable from it operational position shown in FIG. 1. For example, water tray 118 may mounted and/or stored on a side panel of housing 102 as illustrated in FIG. 3 as water tray 304.

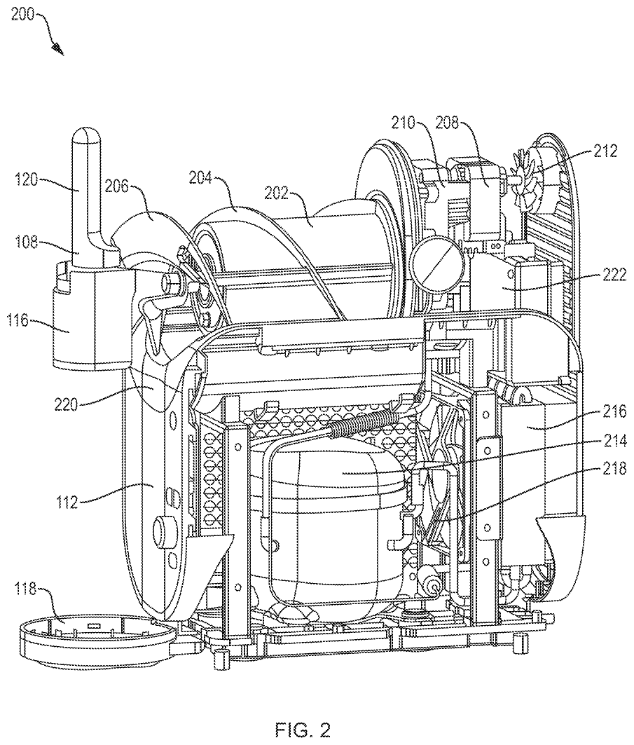

FIG. 2 shows a view 200 of various internal components within housing 102 and mixing vessel 104 of frozen drink maker 100 of FIG. 1. Frozen drink maker 100 includes a cylindrical evaporator 202 that is surrounded by an auger and/or dasher 204. Dasher 204 may include one or more mixing blades and/or protrusions that extend helically around evaporator and/or chiller 202. Dasher 204 may be driven to rotate by a central drive shaft within mixing vessel 104. The drive shaft may be surrounded by evaporator 202. However, in various implementations, evaporator 202 does not rotate. The drive shaft may be coupled via a gear assembly 210 to a drive motor 208. In some implementations, drive motor 208 is an AC motor, but another type of motor may be used such as, without limitation, a DC motor. Drive motor 208 may include a motor fan 212 arranged to provide air cooling for motor 208. While FIG. 2 shows an implementation where drive motor 208 is not coaxially aligned with the drive shaft used to rotate dasher 204, in other implementations, motor 208 can be aligned coaxially with the drive shaft. During processing of a drink product, motor 208 may be continuously operated at a one or more speeds to drive continuous rotation of dasher 204 and, thereby, provide continuous mixing of the drink product within mixing vessel 104. In some implementation, the rotation of the dasher 204 causes the helically arranged blades to push the cooling drink product to the front of the mixing vessel 104. During the processing, portions of the drink product may freeze against the surface of the evaporator as a result of being cooled by the evaporator. In some implementations, the blades of the rotating dasher 204 scrape frozen portions of the drink product from the surface the evaporator while concurrently mixing and pushing the cooling drink product towards the front of the mixing vessel 104.

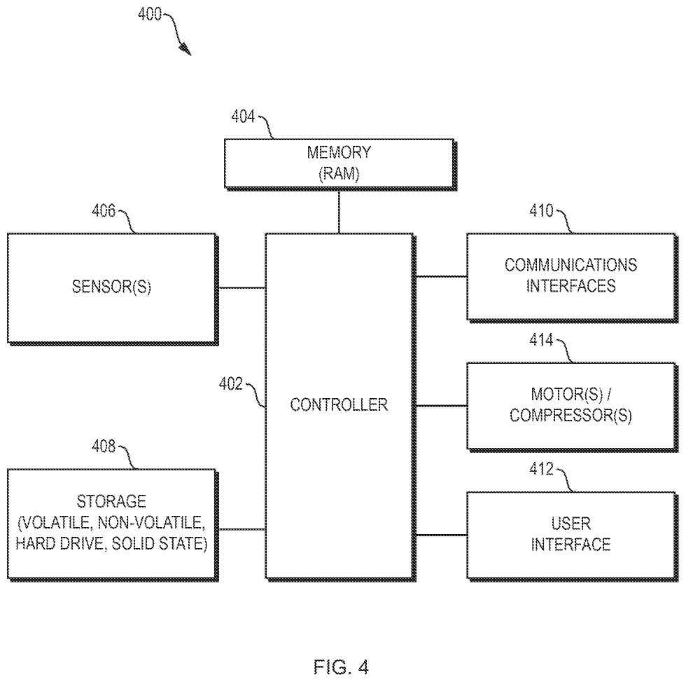

Still referring to FIG. 2, frozen drink maker 100 may include a refrigeration circuit and/or system to provide cooling of a drink product and/or to control the temperature of a drink product within mixing vessel 104. The refrigeration circuit may include a compressor 214, an evaporator 202, a condenser 216, a condenser fan 218, a bypass valve, and conduit that carries refrigerant in a closed loop among the refrigeration circuit components to facilitate cooling and/or temperature control of a drink product in mixing vessel 104. Operations of the refrigeration circuit may be controlled by a controller, such as controller 402, as described further with respect to FIG. 4. Frozen drink maker 100 may also include a removeable collection tray 220 arranged to collect any liquid condensation caused by cooling from evaporator 202. FIG. 2 shows tray 220 in the inserted position. Tray 220 may be insertably removeable from a slot within housing 102 to enable collection of condensed liquid when inserted into the slot and then efficient removal to empty tray 220, and then re-insertion into the slot for subsequent liquid collection, as described further with respect to FIGS. 5A and 5B. Frozen drink maker 100 may also include a printed circuit board assembly (PCBA) 222 within housing 102. As will be explained with respect to FIG. 4, PCBA 222 may include a control system 400 arranged to automatically control certain operations of frozen drink maker 100.

FIG. 3 shows a front view 300 of frozen drink maker 100 of FIG. 1. Frozen drink maker 100 may include user interface 112 on a front surface of housing 102. In other implementations, user interface 112 may be located on a side, top, or back of housing 102. Frozen drink maker may include a mount 302 on a side of housing 102 where drip tray 304 can be mounted when not in use, such as during transport of frozen drink maker 100. Frozen drink maker 100 may include a power interface arranged to receive AC power from a power outlet (not shown). In some implementations, frozen drink maker 100 may include one or more batteries housed within housing 102 and arranged to provide power to various components of frozen drink maker 100.

FIG. 4 is a block diagram illustrating an example of a control system 400 of frozen drink maker 100 according to some implementations of the disclosure. Control system 400 may include a microcontroller, a processor, a system-on-a-chip (SoC), a client device, and/or a physical computing device and may include hardware and/or virtual processor(s). In some implementations, control system 400 and its elements as shown in FIG. 4 each relate to physical hardware, while in some implementations one, more, or all of the elements could be implemented using emulators or virtual machines. Regardless, electronic control system 400 may be implemented on physical hardware, such as in frozen drink maker 100.

As also shown in FIG. 4, control system 400 may include a user interface 212 and/or 112, having, for example, a keyboard, keypad, one or more buttons, dials, touchpad, or sensor readout (e.g., biometric scanner) and one or more output devices, such as displays, speakers for audio, LED indicators, and/or light indicators. Control system 400 may also include communications interfaces 410, such as a network communication unit that could include a wired communication component and/or a wireless communications component, which may be communicatively coupled to controller and/or processor 402. The network communication unit may utilize any of a variety of proprietary or standardized network protocols, such as Ethernet, TCP/IP, to name a few of many protocols, to effect communications between processor 402 and another device, network, or system. Network communication units may also comprise one or more transceivers that utilize the Ethernet, power line communication (PLC), Wi-Fi, cellular, and/or other communication methods. For example, control system 400 may send one or more communications associated with a status of frozen drink maker 100 to a mobile device of a user, e.g., send an alert to the mobile device when a recipe is complete and/or a drink product is ready for dispensing, or to indicate that the mixing vessel is low or out of a drink product.

Control system 400 may include a processing element, such as controller and/or processor 402, that contains one or more hardware processors, where each hardware processor may have a single or multiple processor cores. In one implementation, the processor 402 includes at least one shared cache that stores data (e.g., computing instructions) that are utilized by one or more other components of processor 402. For example, the shared cache may be a locally cached data stored in a memory for faster access by components of the processing elements that make up processor 402. Examples of processors include but are not limited to a central processing unit (CPU) and/or microprocessor. Controller and/or processor 402 may utilize a computer architecture base on, without limitation, the Intel® 8051 architecture, Motorola® 68HCX, Intel® 80X86, and the like. The processor 402 may include, without limitation, an 8-bit, 12-bit, 16-bit, 32-bit, or 64-bit architecture. Although not illustrated in FIG. 4, the processing elements that make up processor 402 may also include one or more other types of hardware processing components, such as graphics processing units (GPUs), application specific integrated circuits (ASICs), field-programmable gate arrays (FPGAs), and/or digital signal processors (DSPs).

FIG. 4 also illustrates that memory 404 may be operatively and communicatively coupled to controller 402. Memory 404 may be a non-transitory medium configured to store various types of data. For example, memory 404 may include one or more storage devices 408 that include a non-volatile storage device and/or volatile memory. Volatile memory, such as random-access memory (RAM), can be any suitable non-permanent storage device. The non-volatile storage devices 408 may include one or more disk drives, optical drives, solid-state drives (SSDs), tape drives, flash memory, read-only memory (ROM), and/or any other type of memory designed to maintain data for a duration time after a power loss or shut down operation. In certain configurations, the non-volatile storage devices 408 may be used to store overflow data if allocated RAM is not large enough to hold all working data. The non-volatile storage devices 408 may also be used to store programs that are loaded into the RAM when such programs are selected for execution. Data store and/or storage devices 408 may be arranged to store a plurality of drink product making and/or processing instruction programs associated with a plurality of drink product processing sequences, i.e., recipes. Such drink product making and/or processing instruction programs may include instruction for controller and/or processor 402 to: start or stop one or motors and/or compressors 414 (e.g., such as motor 208 and/or compressor 214), start or stop compressor 214 to regulate a temperature of a drink product being processed within mixing vessel 104, operate the one or more motors 414 (e.g., motor 208 and/or compressor 214) at certain periods during a particular drink product processing sequence, operate motor 208 at certain speeds during certain periods of time of a recipe, issue one or more cue instructions to user interface 412 and/or 112 that are output to a user to illicit a response, action, and/or input from the user.

Persons of ordinary skill in the art are aware that software programs may be developed, encoded, and compiled in a variety of computing languages for a variety of software platforms and/or operating systems and subsequently loaded and executed by processor 402. In one implementation, the compiling process of the software program may transform program code written in a programming language to another computer language such that the processor 402 is able to execute the programming code. For example, the compiling process of the software program may generate an executable program that provides encoded instructions (e.g., machine code instructions) for processor 402 to accomplish specific, non-generic, particular computing functions.

After the compiling process, the encoded instructions may be loaded as computer executable instructions or process steps to processor 402 from storage 408, from memory 404, and/or embedded within processor 402 (e.g., via a cache or on-board ROM). Processor 402 may be configured to execute the stored instructions or process steps in order to perform instructions or process steps to transform the electronic control system 400 into a non-generic, particular, specially programmed machine or apparatus. Stored data, e.g., data stored by a data store and/or storage device 408, may be accessed by processor 402 during the execution of computer executable instructions or process steps to instruct one or more components within control system 400 and/or other components or devices external to system 400. For example, the recipes may be arranged in a lookup table and/or database within data store 408 and be accessed by processor 402 when executing a particular recipe selected by a user via user interface 412 and/or 112.

User interface 412 and/or 112 can include a display, positional input device (such as a mouse, touchpad, touchscreen, or the like), keyboard, keypad, one or more buttons, one or more dials, a microphone, speaker, or other forms of user input and output devices. The user interface components may be communicatively coupled to processor 402. When the user interface output device is or includes a display, the display can be implemented in various ways, including by a liquid crystal display (LCD) or a cathode-ray tube (CRT) or light emitting diode (LED) display, such as an OLED display.

Sensors 406 may include one or more sensors that detect and/or monitor conditions of a drink product within mixing vessel 104, conditions associated with a component of the frozen drink maker 100, and/or conditions of a refrigerant within the refrigeration system. Conditions may include, without limitation, rotation, speed of rotation, and/or movement of a device or component (e.g., a motor), rate of such movement, frequency of such movement, direction of such movements, motor current, motor voltage, motor power, motor torque, temperature, pressure, fluid level in vessel 104, position of a device or component (e.g., whether pour-in opening 106 is open or closed), and/or the presence of a device or component (e.g., whether shroud 116 is installed or not). Types of sensors may include, for example, electrical metering chips, Hall sensors, pressure sensors, temperature sensors, optical sensors, current sensors, torque sensors, voltage sensors, cameras, other types of sensors, or any suitable combination of the foregoing. Frozen drink maker 100 may include one or more temperature sensors positioned in various locations within mixing vessel 104 such as, for example, on or about the lower front area within mixing vessel 104, on or about the upper front area within mixing vessel 104, on or about the upper rear area within vessel 104, within one or more coils of evaporator 202, and/or within housing 102.

Sensors 406 may also include one or more safety and/or interlock switches that prevent or enable operation of certain components, e.g., a motor, when certain conditions are met (e.g., enabling activation of motor 208 and/or 414 when a lid or cover for opening 106 is attached or closed and/or when a sufficient level of drink product is in vessel 104). Persons of ordinary skill in the art are aware that electronic control system 400 may include other components well known in the art, such as power sources and/or analog-to-digital converters, not explicitly shown in FIG. 4.

In some implementations, control system 400 and/or processor 402 includes an SoC having multiple hardware components, including but not limited to:
a microcontroller, microprocessor or digital signal processor (DSP) core and/or multiprocessor SoCs (MPSoC) having more than one processor cores;
memory blocks including a selection of read-only memory (ROM), random access memory (RAM), electronically erasable programmable read-only memory (EEPROM) and flash memory;
timing sources including oscillators and phase-docked loops;
peripherals including counter-timers, real-time timers and power-on reset generators;
external interfaces, including industry standards such as universal serial bus (USB), Fire Wire, Ethernet, universal synchronous/asynchronous receiver/transmitter (USART), serial peripheral interface (SPI);
analog interfaces including analog-to-digital converters (ADCs) and digital-to-analog converters (DACs); and
voltage regulators and power management circuits.

A SoC includes both the hardware, described above, and software controlling the microcontroller, microprocessor and/or DSP cores, peripherals and interfaces. Most SoCs are developed from pre-qualified hardware blocks for the hardware elements (e.g., referred to as modules or components which represent an IP core or IP block), together with software drivers that control their operation. The above listing of hardware elements is not exhaustive. A SoC may include protocol stacks that drive industry-standard interfaces like a universal serial bus (USB).

Once the overall architecture of the SoC has been defined, individual hardware elements may be described in an abstract language called RTL which stands for register-transfer level. RTL is used to define the circuit behavior. Hardware elements are connected together in the same RTL language to create the full SoC design. In digital circuit design, RTL is a design abstraction which models a synchronous digital circuit in terms of the flow of digital signals (data) between hardware registers, and the logical operations performed on those signals. RTL abstraction is used in hardware description languages (HDLs) like Verilog and VHDL to create high-level representations of a circuit, from which lower-level representations and ultimately actual wiring can be derived. Design at the RTL level is typical practice in modern digital design. Verilog is standardized as Institute of Electrical and Electronic Engineers (IEEE) 1364 and is an HDL used to model electronic systems. Verilog is most commonly used in the design and verification of digital circuits at the RTL level of abstraction. Verilog may also be used in the verification of analog circuits and mixed-signal circuits, as well as in the design of genetic circuits. In some implementations, various components of control system 400 are implemented on a PCB such as PCB 222.

In operation in certain implementations, a user fills mixing vessel 104 via pour-in opening 106 with ingredients associated with a drink product. The user selects the type of drink product to be processed via user interface 112, e.g., the user selects the recipe for “margarita.” In some implementations, the user selects the product type and/or recipe before filling the mixing vessel 104 and the user interface 112 provides one or more indicators or queues (visible and/or audible) that instruct the user to add ingredients to mixing vessel 104. Mixing vessel 104 may include one or more fill sensors that detect when a sufficient amount or level of ingredients and/or fluid is within mixing vessel 104. The one or more fill sensors may provide a signal to processor 402 that indicates when vessel 104 is sufficiently filled or not filled. Processor 402 may prevent operations of the frozen drink maker 100 (e.g., prevent activation of motor 208 and/or other components) if the fill sensor(s) 406 indicate that vessel 104 is not sufficiently filled. A lid sensor may be associated with opening 106 whereby the lid sensor sends an open and/or closed signal to processor 402 that indicates whether opening 106 is open or closed. Processor 402 may prevent operations of the frozen drink maker 100 if the lid sensor indicates that opening 106 is open and/or not closed. Depending on the sensed condition, user interface 112 may provide an indication regarding the condition, e.g., that vessel 104 is sufficiently filled or not sufficiently filled and/or that opening 106 is not closed, to enable a user to take appropriate action(s).

Once mixing vessel 104 is filled with ingredients, the user may provide an input, e.g., a button press, to start processing of the drink product based on the selected recipe. Processing may include activation of motor 208 to drive rotation of dasher 204 and/or blade 206 to effect mixing of the ingredients of the drink product. Processing may also include activation of the refrigeration system including activation of compressor 214 and condenser fan 218. The compressor 214 facilitates refrigerant flow through one or more coils of evaporator 202 and through condenser 216 to provide cooling and/or temperature control of the drink product within mixing vessel 104. Processor 402 may control operations of various components such as motor 208 and compressor 214. To regulate temperature at a particular setting associated with a recipe, processor 402 may activate/start and/or de-activate/stop compressor 214 to start and/or stop refrigerant flow through the coil(s) of evaporator 202 and, thereby, start or stop cooling of the drink product within mixing vessel 104.

By cooling a drink product to a particular temperature, slush and/or ice particles may be formed within the drink product. Typically, the amount of particles and/or texture of a drink product corresponds to a temperature of the drink product, i.e., the cooler the temperature—the larger the amount of particles (and/or the larger the size of particles) and/or the more slushy the drink product. User interface 112 may enable a user to fine tune and/or adjust a preset temperature associated with a recipe to enable a user to adjust the temperature and/or texture of a drink product to a more desirable temperature and/or texture.

Processor 402 may perform processing of the drink product for a set period of time in one or more phases and/or until a desired temperature and/or texture is determined. Processor 402 may receive one or more temperature signals from one or more temperature sensors 408 within mixing vessel 104 to determine the temperature of the drink product. Processor 402 may determine the temperature of the drink product by determining an average temperature among temperatures detected by multiple temperature sensors 408. Processor 402 may determine the temperature of the drink product based on the detected temperature from one sensor 408 within mixing vessel 104 and/or based on a temperature of the refrigerant detected by a refrigerant temperature sensor 408. Once a phase and/or sequence of a recipe is determined to be completed by processor 402, processor 402 may, via user interface 116, provide a visual and/or audio indication that the recipe is complete and ready for dispensing. In response, a user may place a cup or container below dispenser assembly 108 and pull handle 120 rotationally downward towards the user to open a spout located at the lower front wall of mixing vessel 104, resulting in dispensing of the drink product into the cup or container. Once filled, the user can close the spout by pushing handle 120 back rotationally upward away from the user to its upright position shown in FIG. 2. In implementations where handle 120 is spring biased to the closed position, the user can release their hold of handle 120 and, thereby, allow a spring force to move handle 120 back rotational upward away from the user to the upright and closed position.

FIGS. 5A-5D show a dispensing assembly 500 for dispensing a drink product from the frozen drink maker 100 according to a first illustrative implementation of the disclosure. As shown in FIG. 5A, the dispensing assembly 500 may include a dispenser housing 504 for housing the component parts of the dispensing assembly 500. The housing 504 may have a first portion 504a attached to an outer surface of the frozen drink maker 100 adjacent to a spout 502 and a second portion 504b spaced apart from the spout 502 and extending outward from the outer surface. In some implementations, the housing 504 may have an inverted L-shape. However, the disclosure contemplates other suitable shapes of the housing 504. The handle 120 of the frozen drink maker 100 may have an upper portion 120a in the form of a user-actuatable lever 506 and a lower portion 120b attached to the second portion 504b of the housing 504.

As shown in FIGS. 5B and 5C, the lever 506 may be rotatable relative to the second portion 504b of the housing 504 about a first pivot member 508. In some implementations, the first pivot member 508 may be a rod or pin 510 extending through the second portion 504b of the housing 504 and the lower portion 120b of the handle 120. However, the disclosure contemplates other suitable types of pivot members 508. A link member 512 may operatively couple to the lower portion 120b of the handle 120. In some implementations, the link member 512 may be insertable into the lower portion 120b of the handle 120. The link member 512 may be rotatable relative to the lever 506 about a second pivot member 514. In some implementations, the second pivot member 514 may be a rod or pin 516 extending through the link member 512 and through the lower portion 120b of the handle 120. However, the disclosure contemplates other suitable types of pivot members 516. A bracket member 518 may operatively couple to the link member 512 and may be attached to the first portion 504a of the housing 504. In some implementations, the link member 512 may be insertable into a portion bracket member 518. The bracket member 518 may be rotatable relative to the link member 512 about a third pivot member 520. In some implementations, the third pivot member 520 may be a rod or pin 522 extending through the bracket member 518 and the link member 512. However, the disclosure contemplates other suitable types of pivot members 520. The bracket member 518 may also be rotatable relative to the first portion 504a of the housing 504 about a fourth pivot member 524. In some implementations, the fourth pivot member 524 may be a rod or pin 526 extending through the first portion 504a of the housing 504 and the bracket member 518. However, the disclosure contemplates other suitable types of pivot members 524. A seal 528 may attach to the bracket member 518. The seal 528 may be configured to seal the spout 502 to prevent inadvertent dispensing of the drink product. In some implementations, the seal 528 may be a lip seal that covers the spout 502. However, other suitable types of seals 528 are contemplated by this disclosure. For example, in some implementations, the seal 528 may be, or may include, a plug that is made out of one or more relatively dense materials having a relatively high durometer and that extends into the spout 502 to seal the spout 502. The spout 502 may include a safety grate 530 or other mechanism to prevent the user from inadvertently inserting his or her fingers into the spout 502 (FIG. 5D).

To dispense the drink product, in some implementations, actuation of the lever 506 by the user may cause the link member 512 to move upward relative to the housing 504. Because the bracket member 518 is attached to both the link member 512 and to the housing 504, a portion of the bracket member 518 may move upward with the link member 512 while the remainder of the bracket member 518 is forced to pivot about fourth pivot member 524. This in turn may cause the seal 528 to move into an open position. When the seal 528 moves into the open position, the seal 528 may uncover the spout 502 to dispense the drink product. Advantageously, in the open position, the seal 528 may be angled at about 45-60 degrees with respect to the spout 502 to direct the drink product downward toward the beverage cup. Release of the lever 506 by the user may allow the components to return to their unactuated position, allowing the seal 528 to again close the spout 502.

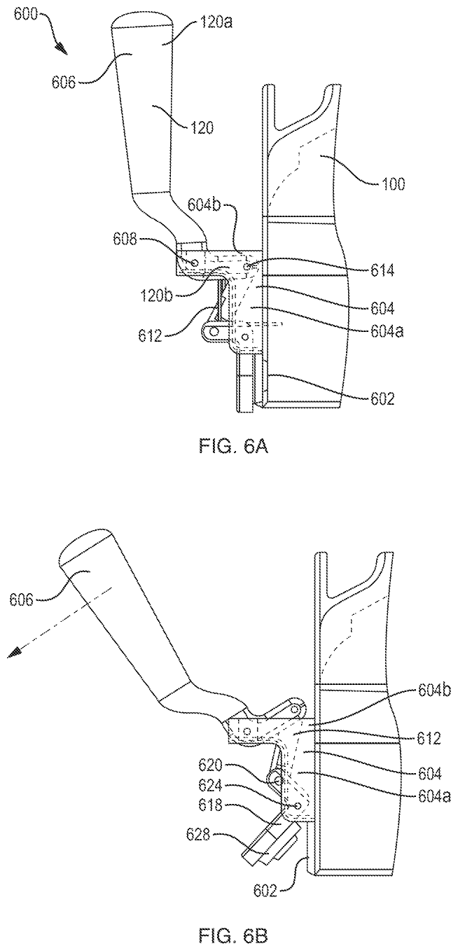

FIGS. 6A and 6B show a dispensing assembly 600 for dispensing a drink product from the frozen drink maker 100 according to a second illustrative implementation of the disclosure. Dispensing assembly 600 may be substantially similar to dispensing assembly 500. For example, as shown in FIG. 6A, the dispensing assembly 600 may include a dispenser housing 604 for housing the component parts of the dispensing assembly 600. The housing 604 may have a first portion 604a attached to an outer surface of the frozen drink maker 100 adjacent to a spout 602 and a second portion 604b spaced apart from the spout 602 and extending outward from the outer surface. The handle 120 may have an upper portion 120a in the form of a user-actuatable lever 606 and a lower portion 120b attached to the second portion 604b of the housing 604. The lever 606 may be rotatable relative to the second portion 604b of the housing 604 about a first pivot member 608. A link member 612 may operatively couple to the lower portion 120b of the handle 120. The link member 612 may be rotatable relative to the lever 606 about a second pivot member 614.

As shown in FIG. 6B, a bracket member 618 may operatively couple to the link member 612 and may be attached to the first portion 604a of the housing 604. In some implementations, the bracket member 618 may have an inverted L-shape, as shown. However, the disclosure contemplates other suitable shapes of the bracket member 618. The bracket member 618 may be rotatable relative to the link member 612 about a third pivot member 620. The bracket member 618 may also be rotatable relative to the first portion 604a of the housing 604 about a fourth pivot member 624. A seal 628 may attach to the bracket member 618. The seal 628 may be configured to seal the spout 602 in a closed position. In some implementations, the seal 628 may be a lip seal that covers the spout 602. However, in some implementations, the seal 628 may be, or may include, a plug that is made out of one or more relatively dense materials having a relatively high durometer and that extends into the spout 602 to seal the spout 602.

To dispense the drink product, in some implementations, actuation of the lever 606 by the user may cause the link member 612 to move upward relative to the housing 604. Because the bracket member 618 is attached to both the link member 612 and to the housing 604, a portion of the bracket member 618 may move upward with the link member 612 while the remainder of the bracket member 618 is forced to pivot about fourth pivot member 624. This in turn may cause the seal 628 to move into an open position. When the seal 628 moves into the open position, the seal 628 may uncover the spout 602 to dispense the drink product. Advantageously, in the open position, the seal 628 may be angled at about 45-60 degrees with respect to the spout 602 to direct the drink product downward toward the beverage cup. Release of the lever 606 by the user may allow the components to return to their unactuated position, allowing the seal 628 to again close the spout 602.

Advantageously, unlike other dispenser mechanisms, the dispensing assemblies 500, 600 of this disclosure do not rely on leverage against the outer surface of the frozen drink maker 100 to open the seal 528, 628. This may reduce wear and tear of the component parts of the dispensing assembly 500, 600 and on the outer surface of the frozen drink maker 100. Furthermore, because the seal 528, 628 moves both horizontally and vertically with respect to the spout 502, 602 to unseal the spout 502, 602, the open position of the seal 528, 628 may provide less obstruction to the flow of the drink product from the spout 502, 602.

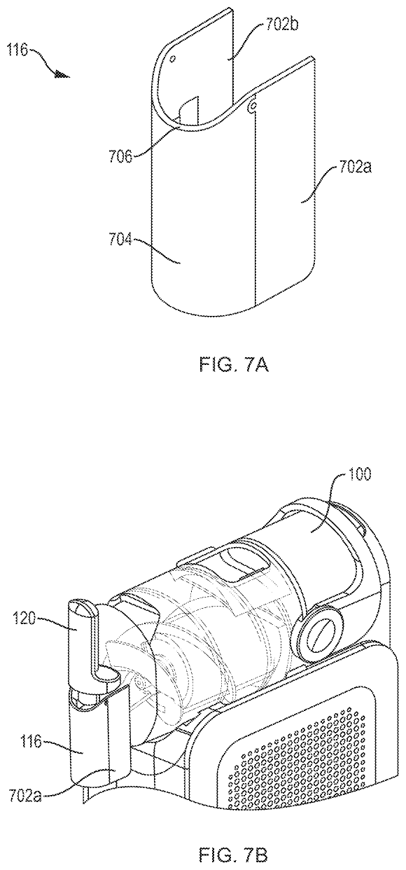

FIGS. 7A and 7B illustrate in greater detail the spout cover or shroud 116 for covering a portion of the dispensing assembly 500, 600 according to an illustrative implementation of the disclosure. As shown in FIG. 7A, the shroud 116 may include a first panel section 702a and a second panel section 702 extending substantially parallel to one another. A front section 704 may extend between the panel sections 702a, 702b. In some implementations, the panel sections 702a, 702b may be substantially flat, while the front section 704 may be curved, as shown. In some implementations, the front section 704 may include an arcuate upper edge 706 configured such that actuation of the handle 120 is not impeded. However, the disclosure contemplates other suitable shapes of the upper edge 706, such as the rectilinear shape shown in FIG. 1. As shown in FIG. 7B, the panel sections 702a, 702b may be configured to form a removable snap fit with the dispenser housing 504, 604. A length of the shroud 116 may be selected to cover the component parts of the dispensing assemblies 500, 600 other than the handle 120 to improve the aesthetic appearance of the frozen drink maker 100. The shroud 116 may also aid in directing the drink product downward toward the beverage cup. The shroud 116 may be made of a dishwasher safe material for easy cleaning.

In some implementations, at least the front section 704 of the shroud 116 may be vertically moveable relative to the dispensing assembly 500, 600. For example, in some implementations, the front section 704 may be moveable relative to the first panel section 702a and the second panel section 702b. In some implementations, the front section 704 may be hingedly connected to the first and second panel sections 702a, 702b or may be vertically slidable relative the first and second panel sections 702a, 702b. Such movement may be useful when dispensing a non-frozen, water-based beverage to prevent the beverage from dispensing at too lateral of a trajectory from the spout 502, 602. Such a lateral trajectory may result in at least a portion of the beverage not dispensing into a receiving vessel located below the spout 502, 602.

It should be appreciated that the various implementations described herein are not limited to making frozen or semi-frozen drinks, but may be applied to produce a cold and/or cooled drink product that is cooler than a received drink product, but not frozen or semi-frozen. For example, in some implementations, the same or similar mechanisms and/or techniques may be used as part of a cold drink machine and/or cooled drink maker to produce, maintain and dispense cold drinks.

As discussed with respect to FIG. 4, actions associated with configuring or controlling a frozen drink maker such as frozen drink maker 100 and processes described herein can be performed by one or more programmable processors executing one or more computer programs to control or to perform all or some of the operations described herein. All or part of the frozen drink maker 100 systems and processes can be configured or controlled by special purpose logic circuitry, such as, an FPGA and/or an ASIC or embedded microprocessor(s) localized to the instrument hardware.

Non-transitory machine-readable storage media suitable for embodying computer program instructions and data include all forms of non-volatile storage area, including by way of example, semiconductor storage area devices, such as EPROM (erasable programmable read-only memory), EEPROM (electrically erasable programmable read-only memory), and flash storage area devices; magnetic disks, such as internal hard disks or removable disks; magneto-optical disks; and CD-ROM (compact disc read-only memory) and DVD-ROM (digital versatile disc read-only memory).

Elements of different implementations described may be combined to form other implementations not specifically set forth previously. Elements may be left out of the systems described previously without adversely affecting their operation or the operation of the system in general. Furthermore, various separate elements may be combined into one or more individual elements to perform the functions described in this specification.

What is claimed is:

1. A dispensing assembly for a frozen drink maker, the dispensing assembly comprising:
a housing comprising:
a first portion attached to an outer surface of the frozen drink maker adjacent to a spout; and
a second portion spaced apart from the spout and extending outward from the outer surface;
a lever attached to the second portion of the housing, the lever being rotatable relative to the second portion of the housing about a first pivot member; and
a seal operatively coupled to the lever, the seal configured to seal the spout in a closed position;
wherein rotation of the lever causes the seal to move into an open position to allow dispensing of a drink product through the spout.

2. The dispensing assembly of claim 1, further comprising:
a link member operatively coupled to the lever, the link member being rotatable relative to the lever about a second pivot member; and
a bracket member operatively coupled to the link member and attached to the first portion of the housing, the bracket member being rotatable relative to the link member about a third pivot member and rotatable relative to the first portion of the housing about a fourth pivot member;
wherein the seal is attached to the bracket member.

3. The dispensing assembly of claim 2, wherein the second pivot member comprises a pin extending through the lever and through the link member.

4. The dispensing assembly of claim 2, wherein the third pivot member comprises a pin extending through the bracket member and through the link member.

5. The dispensing assembly of claim 2, wherein the fourth pivot member comprises a pin extending through the first portion of the housing and through the bracket member.

6. The dispensing assembly of claim 1, wherein the seal is angled at about 45-60 degrees with respect to the spout when the seal is in the open position.

7. The dispensing assembly of claim 1, wherein the spout comprises a grate configured to prevent a user from inserting fingers into the spout.

8. The dispensing assembly of claim 1, wherein the first pivot member comprises a pin extending through the second portion of the housing and through the lever.

9. The dispensing assembly of claim 1, wherein the seal is a lip seal.

10. The dispensing assembly of claim 1, wherein the bracket member is L-shaped.

11. The dispensing assembly of claim 1, wherein the housing is L-shaped.

12. A method of dispensing a drink product through a spout of a frozen drink maker, the method comprising:
rotating a lever about a first pivot member relative to a second portion of a housing of a dispensing assembly, the housing further comprising:
a first portion attached to an outer surface of the frozen drink maker adjacent to the spout; and
the second portion spaced apart from the spout and extending outward from the outer surface;
wherein rotating the lever causes a seal operatively coupled to the lever to move into an open position to allow dispensing of the drink product through the spout; and
wherein the seal is configured to seal the spout in a closed position.

13. The method of claim 12, wherein the dispensing assembly further comprises a link member operatively coupled to the lever; and wherein rotating the lever causes the link member to rotate relative to the lever about a second pivot member.

14. The method of claim 13, wherein the dispensing assembly further comprises a bracket member operatively coupled to the link member and attached to the first portion of the housing, and wherein rotating the lever causes the bracket member to rotate relative to the link member about a third pivot member and to rotate relative to the first portion of the housing about a fourth pivot member.

15. The method of claim 14, wherein the seal is attached to the bracket member.
